(19) United States
(12) Patent Application Publication
(10) Pub. No.: US 2025/0050349 A1
(43) Pub. Date: Feb. 13, 2025

(54) LINER PLATE IN CONNECTION TO A MATERIAL PROCESSING HANDLING SYSTEM

(71) Applicant: SANDVIK SRP AB, Svedala (SE)

(72) Inventor: Hodin ESBELANI, Svedala (SE)

(21) Appl. No.: 18/719,395

(22) PCT Filed: Dec. 21, 2022
(86) PCT No.: PCT/EP2022/087281

§ 371 Date: Jun. 13, 2024

(30) Foreign Application Priority Data
Dec. 21, 2021 (EP) 21216238.2

(51) Int. Cl. B02C 2/00

(52) U.S. Cl. CPC B02C 2/005; B02C 2210/02

(57) ABSTRACT

A liner plate is arranged in connection with a material processing handling system, wherein the liner plate includes edge protection. The edge protection has a plurality of primary wear tiles arranged side by side along at least one edge of the plate. The wear tiles have a frontside and a backside including at least one backward protrusion protruding into the plate.

### TECHNICAL FIELD

The present application relates generally to a liner plate. More specifically, the present application relates to a liner plate arranged in connection to a material processing handling system (material processing unit equipment).

### BACKGROUND

Material extracted underground or above ground, that results in large pieces of material that require a reduction in size with the use of a crusher. There exist a great variety of crushers, both for mining purposes and for construction purposes. Crushers are part of a material processing handling system were material to be crushed needs to be transported to the crusher before becoming crushed and needs to be transported from the crusher after having been crushed.

Plates mounted in connection to these material processing handling systems can both be an active part of the crushing process and be a passive part of the crushing process. Material travelling to or from the crusher normally passes a chute or a hopper, in which plates have a passive role in the crushing process. One type of crusher is a VSI (vertical shaft impact) type of crusher, in such a crusher commonly a plate arranged in connection to the outlet may be a cavity wear part that has an active role in the crushing process.

The transportation of material into and out from the crusher influences the surrounding equipment by wear. So, the equipment coming into contact with the material to become crushed or having been crushed is often worn down since the material to be crushed is heavy material such as pieces of rock, stones etc. that impact the surroundings with large forces.

Thus, what is required is a plate in connection to material processing handling systems that addresses the above problems.

### SUMMARY

Various aspects of examples of the invention are set out in the claims. The scope of protection sought for various embodiments of the invention is set out by the independent claims. The examples and features, if any, described in this specification that do not fall under the scope of the independent claims are to be interpreted as examples useful for understanding various embodiments of the invention.

The transportation of material into and out from the crusher requires equipment that is not prone to wear, so the plates (coming into contact with the transported material) need to be durable and robust. Moreover, the plates should be replaceable.

It is an object of the present application to provide a plate that is wear resistant. Further it is an object of the present application to provide a plate that eventually when worn out can easily be replaced.

According to a first aspect of the invention, there is provided a liner plate arranged in connection to a material processing handling system wherein the liner plate comprising edge protection. The edge protection comprising a plurality of primary wear tiles arranged side by side along at least one edge of the plate, and wherein the wear tiles having an outer frontside and a backside comprising at least one backward protrusion protruding into the plate. Thereby a robust liner plate is achieved that has a reinforced part along the edge that is most prone to wear. As an example, the plates can be mounted in connection to a conveyor belt where the plates are arranged vertically side by side along the belt with the edge protection at the downward facing side. By having edge protection on the plates, the plates need not to be changed as often as without a reinforced edge.

Optionally, the backward protrusion having a length protruding into the plate by a specific backward oriented protruding length that is at least 1/20 of the width of the frontside. The protruding length of anchoring could also be ⅕, ¼, ⅖, ½, ⅗, ¾, 4/5 . This gives a rigid anchoring of the wear tiles.

Preferably, the plate comprising an upper layer and a lower layer, wherein the upper layer is a wear protection layer comprising cemented carbides (a form of hard metal). The upper layer may be a mixture of different materials, where one of them is cemented carbides. The upper layer is the layer that comes into contact with the material to be crushed and thus, is the surface that will wear down. So, this design protects the plate from wear.

Preferably, the primary wear tiles comprising cemented carbides. So, the tiles can keep their shape longer, and not needing to be replaced too often.

Optionally, the wear tiles having an outer frontside comprising a flat surface. In a chute this might be preferred so that the plate can be mounted close to the feeder. The flat surface is a rectangle that can be a square with each side having equal length or two opposing sides being longer than the other two opposing sides.

Optionally the wear tiles having an outer frontside comprising a rounded surface. A round outside is less prone to chipping. The roundness might be symmetrical with a spherical or ballistic shape or it might be asymmetrical with an oval shape.

Preferably, the backside of the wear tiles comprising upper protrusions protruding into the plate and lower protrusions protruding into the plate. Both upper and lower protrusion might be identical in shape and extension, or they differ to each other. The protrusions could be along a straight axis or they could include mainly perpendicular extensions in order to have a comb like form. By having two protrusions the tiles are gripping around the plate and are firmly kept in place.

Optionally, the backside of the wear tiles comprising a protrusion protruding from mid-portion of the wear tile into the plate. This type of protrusion could have a straight longitudinal extension, it can be rounded, funnel shaped or any other shape of a protruding “leg”.

Preferably, the plate comprising a second row of secondary wear tiles being arranged in connection to the upper layer and having an outside being perpendicular to the frontside of the primary wear tiles, wherein the secondary wear tiles are arranged side by side. The tiles can be arranged adjacent to each other, so they are in contact with each other or there could be a very short distance between each of them. The secondary wear tiles may have an outside that is rectangular, e.g. a square or round as a circle. The secondary wear tiles may have a rounded backside. The secondary wear tiles could be tilted such that they deviate from being perpendicular to the frontside of the primary wear tiles, the angle of the frontside of the secondary wear tiles in relation to the frontside of the primary wear tiles could be in the range of 45° to 135°.

Optionally, the plate comprising a further edge protection opposite of the first edge protection wherein the further edge protection comprising a second row of primary wear tiles. By having edge protection on two sides of the plate, the plate becomes more rigid and even less prone to wear.

In any embodiment, the liner plate comprises a matrix material and the wear tiles comprise cemented carbides metallurgically bonded to the matrix material. The metallurgical bond is of improved strength compared with non-metallurgical bonds and enhances the wear resistance of the liner plate.

In any embodiment, the primary wear tiles are cast in the metal matrix material. This ensures optimal metallurgical bond formation.

In any embodiment, the matrix material comprises iron which can be nodular iron or similar. The metallurgical bond formed between cemented carbides and iron is a strong metallurgical bond.

### BRIEF DESCRIPTION OF THE DRAWINGS

Some example embodiments will now be described with reference to the accompanying drawings:

FIG. 1 shows an embodiment of a liner plate;

FIG. 2 shows a further embodiment of a liner plate;

FIG. 3 discloses a further embodiment of a liner plate;

FIG. 4 discloses a further embodiment of a liner plate;

FIG. 5 shows a further embodiment of a liner plate; and

FIG. 6 shows a further embodiment of a liner plate.

### DETAILED DESCRIPTION OF THE DRAWINGS

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

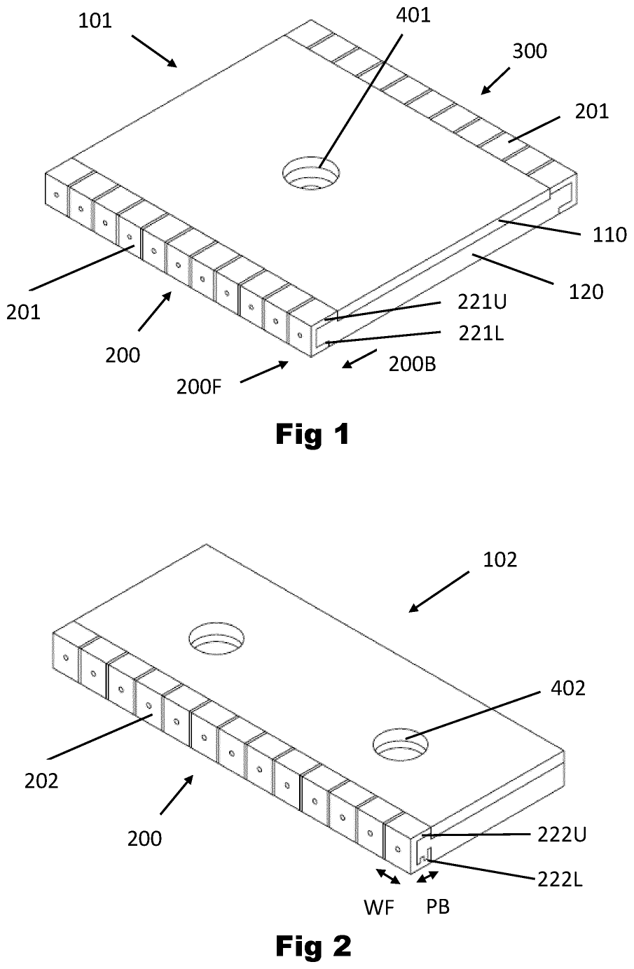

FIG. 1 discloses a first embodiment of a liner plate 101 with a mainly square shaped form where each edge has a substantial similar length. The liner plate is securely kept in place in connection to the equipment of the material processing handling system by a mounting (not shown) in a through hole 401. The through hole is centrally placed on the plate. The plate comprises a first edge protection 200. This edge protection comprises a plurality of primary wear tiles 201 arranged closely side by side with a flat outside being defined as a frontside 200F. The frontside has a square shaped outside. The backside 200B of the wear tiles encapsules the edge of the plate by two backward oriented protrusions, an upper protrusion 221U and a lower protrusion 221L. These protrusions may have substantially the same length or as shown in the drawing where the upper protrusion is somewhat longer than the lower protrusion.

Along the opposite edge of the edge protection 200 the plate comprises a second edge protection 300. This further edge protection 300 constitutes of primary wear tiles 201 arranged closely side by side in a similar way as the first edge protection 200, a mirrored version of the same.

The liner plate 101 comprises two layers, an upper layer 110 and a lower layer 120. The upper layer is a wear protection layer comprising cemented carbides and the lower layer can be any type of metal material, normally the lower layer 120 is made of a softer material than the upper layer 110. This layered composition of the liner plate is the same for all embodiments in the figures.

In one embodiment, the liner plate 101 is formed from a (metal) matrix material such as iron (e.g. nodular iron) and the primary wear tiles 201 comprise cemented carbide(s) metallurgically bonded to the matrix material. The primary wear tiles 201 can comprise cemented carbide either wholly or in part. The metallurgical bond between the matrix material of the liner plate 101 and the primary wear tiles 201 are formed by casting the cemented carbide primary wear tiles 201 in the metal matrix material which is preferably nodular iron. The resultant metallurgical bond between the matrix material of the liner plate 101 and the cemented carbide of the wear tile 201 is enhanced by the upper protrusion 221U and the lower protrusion 221L to provide an integrated liner plate 101 with optimal wear resistance. More particularly, the protrusions 221U,221L provide an increased area of contact between the matrix material/liner plate 101 and the cemented carbide of the primary wear plate 201 to provide a stronger metallurgical bond resulting in improved wear resistance and a prolonged service life. FIG. 2 discloses a further embodiment of a liner plate 102 as a secondary example of a liner plate. This embodiment has a mainly rectangular shaped form where two opposing edges have a substantially shorter length than the other two opposing edges. One of the two longer edges comprises a first edge protection 200. This edge protection comprises a plurality of primary wear tiles 202 arranged closely side by side. As in the first embodiment the tiles have a flat frontside and a protruding backside (corresponding to reference numbers 200F and 200B in FIG. 1). The frontside has a square shaped outside.

The backside of the wear tiles encapsules the edge of the plate by two backward oriented protrusions, an upper protrusion 222U and a lower protrusion 222L. These protrusions may have substantially the same length as shown in the drawing or they may have different lengths. The protruding length of the backward protrusions is defined as PB and the width of the frontside of each tile is defined as WF. This is valid for all embodiments, however the references are only included in FIG. 2.

The protrusions 222U, 222L have substantially the same length PB as the width of the frontside WF. However, the length of the protrusions PB might only be a part of the width of the frontside WF, which is sufficient for a firm placement of the tiles. The length of the protrusions PB range from 5% of the width of the frontside WF to having the same length as the width. The length of the protrusions PB might also be 10%, 15%, 30%, 35%, 45%, 55%, 65%, 70%, 85%, 90% or 95% of the width of the frontside WF. The relation between the length of the protruding backside PB and the width of the frontside WF is applicable to all embodiments.

The upper protrusion 222U has a straight extending length and the lower protrusion 222L comprises teeth extending into the plate perpendicular from the protrusion. Two teeth are shown in the drawing, wherein the most backward teeth is the longer one, however the extension of the teeth might also be reversed and the number of teeth might also be higher or lower.

The liner plate 102 is securely kept in place in connection to the equipment of the material processing handling system by mountings (not shown) in through holes 402.

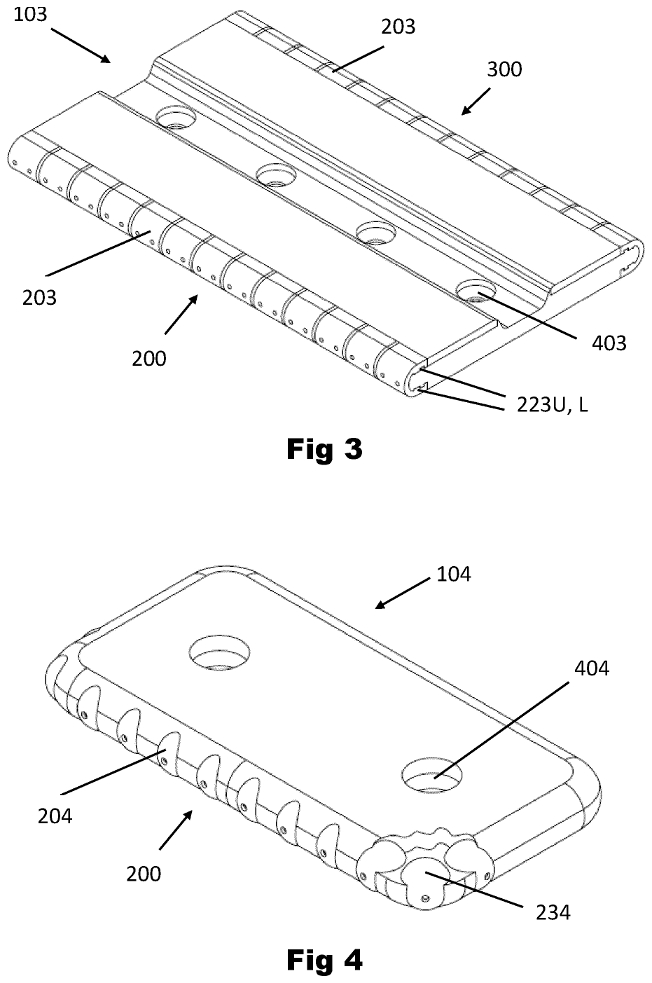

FIG. 3 discloses a further embodiment of a liner plate 103 as a third example of a liner plate. In this embodiment the plate has a mainly rectangular shaped form where two opposing edges have a substantially shorter length than the other two opposing edges. The plate comprises a first edge protection 200 on one of the two longer edges. This edge protection comprises a plurality of primary wear tiles 202 arranged closely side by side. Contrary to the first shown embodiments the tiles 203 have a rounded frontside and a protruding backside (corresponding to reference numbers 200F and 200B in FIG. 1).

The backside of the wear tiles encapsules the edge of the plate by two backward oriented protrusions, an upper protrusion 223U and a lower protrusion 223L. These protrusions may have substantially the same length as shown in the drawing or they may have different lengths.

Both the upper protrusion 223U and the lower protrusion 223L comprise teeth extending into the plate perpendicular from the protrusion. Each protrusion comprises two teeth disclosed in the drawing. The number of teeth might also be higher or lower and the length of the extension of the teeth might vary.

Along the opposite edge of the edge protection 200 the plate comprises a second edge protection 300. This further edge protection 300 constitutes of primary wear tiles 203 arranged closely side by side in a similar way as the first edge protection 200, a mirrored version of the same.

The liner plate 103 is securely kept in place in connection to the equipment of the material processing handling system by mountings (not shown) in through holes 403. These through holes are arranged centrally in the plate, where the plate has an indentation.

FIG. 4 discloses a further embodiment of a liner plate 104 as a fourth example of a liner plate. This embodiment has a mainly rectangular shaped form where two opposing edges have a substantially shorter length than the other two opposing edges. One of the two longer edges comprises a first edge protection 200. This edge protection comprises a plurality of primary wear tiles 204 arranged side by side. In this embodiment the tiles 204 have a rounded frontside and a protruding backside (corresponding to reference numbers 200F and 200B in FIG. 1).

The backside of the wear tiles 204 protrude from the edge of the plate towards the center of the plate, where each tile has a rounded extending protrusion 234. The wear tiles are embedded in the plate such that only a part of each wear tile is visible. The shape of each wear tile and its protrusion might be round or oval.

The liner plate 104 is securely kept in place in connection to the equipment of the material processing handling system by mountings (not shown) arranged in through holes 404. Two through holes are placed centrally on the plate.

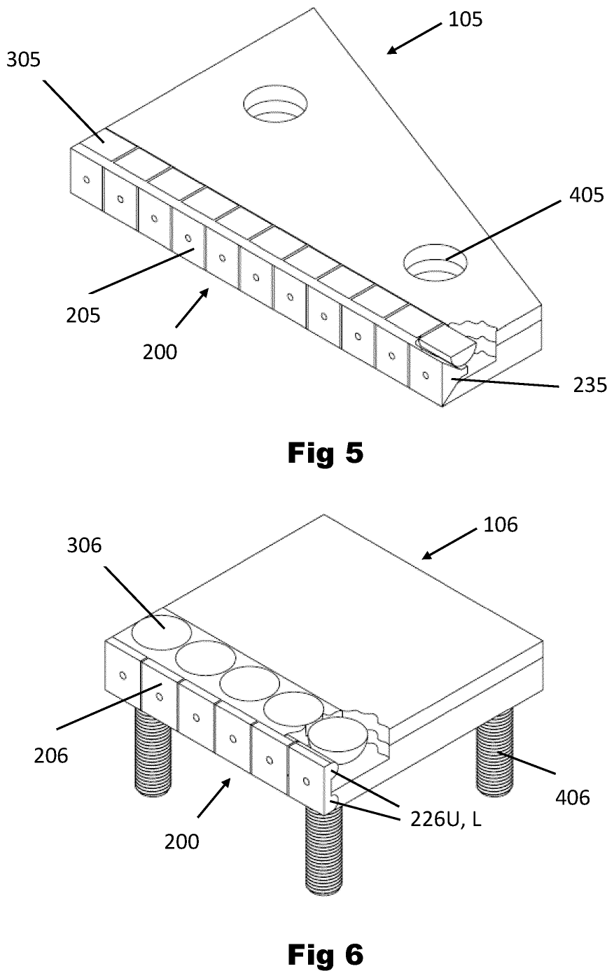

FIG. 5 discloses a further embodiment of a liner plate 105 as a fifth example of a liner plate. This embodiment has a truncated rectangular shape where two opposing edges have a substantially shorter length than the other two edges. The first of the longer edges is perpendicular to the shorter edges, whereas the second of the longer edges connects to the shorter edges with supplementary angles, so that at one end of this longer edge the connecting angle is larger than 90° and at the other end the angle is smaller than 90°. The first of the two longer edges comprises a first edge protection 200. This edge protection comprises a plurality of primary wear tiles 205 arranged closely side by side. As in some earlier embodiments the tiles have a flat frontside and a protruding backside (corresponding to reference numbers 200F and 200B in FIG. 1).

The backward protrusion 235 is funnel shaped, and points centrally into the plate.

A second row of secondary wear tiles 305 complements the edge protection 200. The secondary wear tiles 305 are arranged in the upper layer of the plate 105 and these wear tiles 305 have a flat frontside and a rounded protruding backside. The frontside of each wear tile 305 is square shaped. The frontside being in a plane perpendicular to the frontside of the primary wear tiles 205 and the rounded backside is complementary shaped to the funnel shaped protruding leg of the primary wear tiles 205.

The liner plate 105 is securely kept in place in connection to the equipment of the material processing handling system by mountings (not shown) arranged in through holes 405. Two through holes are placed centrally on the plate.

FIG. 6 discloses a further embodiment of a liner plate 106 as a sixth example of a liner plate. This plate has a mainly square shaped form where each edge has a substantial similar length. The plate comprises a first edge protection 200 along one of the edges. This edge protection comprises a plurality of primary wear tiles 206 arranged closely side by side. As in the first embodiment the tiles have a flat frontside and a protruding backside (corresponding to reference numbers 200F and 200B in FIG. 1). The frontside is square shaped.

The backside of the wear tile has two backward oriented protrusions, an upper protrusion 226U and a lower protrusion 226L. These protrusions may have substantially the same length as shown in the drawing or they may have different lengths. The protruding length of the backward protrusions is defined as PB, as defined in FIG. 2. The protrusions have a rounded backside, so that the tile seen in perspective resembles to the letter B.

A second row of secondary wear tiles 306 complements the edge protection 200. The secondary wear tiles 306 are arranged in the upper layer of the plate 106 and these wear tiles 306 have a flat frontside and a rounded protruding backside. The frontside of each wear tile 306 has the form of a circle and the tiles are placed so the circles are adjacent to each other. The frontside being in a plane perpendicular to the frontside of the primary wear tiles 206. The diameter of the frontside of the secondary wear tiles 306 is comparable to the width of the frontside WF (defined in FIG. 2) of the primary wear tiles 206, the diameter could be slightly larger (as seen in FIG. 6) or the same or slightly smaller.

The liner plate 106 is securely kept in place in connection to the equipment of the material processing handling system by bolts 406 that are casted in the liner arranged in through holes on the lower side of the plate 106. The number of bolts is four and they are arranged in a square close to the corners of the plate.

In all embodiments the primary wear tiles are shown in the drawings to comprise a through hole. This hole can also be omitted. As for the secondary wear tiles no hole is depicted. These wear tiles could also include holes.

As seen in the various examples the fixture of the plate can either be made by one or several through holes in the plate, or by bolts fixed in the lower layer. Another option is to mount a threaded rod in a cavity in the lower layer.

Although various aspects of the invention are set out in the independent claims, other aspects of the invention comprise other combinations of features from the described embodiments and/or the dependent claims with the features of the independent claims, and not solely the combinations explicitly set out in the claims.

It will be obvious to a person skilled in the art that, as the technology advances, the inventive concept can be implemented in various ways. The invention and its embodiments are not limited to the examples described above but may vary within the scope of the claims.

1. A liner plate arranged in connection to a material processing handling system, the liner plate comprising edge protection, the edge protection including a plurality of primary wear tiles arranged side by side along at least one edge of the liner plate, and wherein each of the plurality of primary wear tiles has a frontside and a backside, the backside having at least one backward protrusion protruding into the plate.

2. The plate according to claim 1, wherein the backward protrusion has a length protruding into the plate by a specific backward oriented protruding length that is at least 1/20 of a width of the frontside.

3. The plate according to claim 1, further comprising an upper layer and a lower layer, wherein the upper layer is a wear protection layer comprising cemented carbides.

4. The plate according to claim 1, wherein the plurality of primary wear tiles comprise cemented carbides.

5. The plate according to claim 1, wherein the frontside has an outer flat surface.

6. The plate according to claim 1, wherein the frontside has an outer rounded surface.

7. The plate according to claim 1, wherein the backside of the plurality of primary wear tiles include upper protrusions protruding into the plate and lower protrusions protruding into the plate.

8. The plate according to claim 1, wherein the backside of each of the plurality of primary wear tiles includes a protrusion protruding from a mid-portion thereof into the plate.

9. The plate according to claim 1, further comprising a row of secondary wear tiles arranged in connection to the upper layer and having an outside perpendicular to the frontside of the plurality of primary wear tiles, wherein the secondary wear tiles are arranged side by side.

10. The plate according to claim 1, further comprising a further edge protection opposite of the first edge protection, wherein the further edge protection includes a row of primary wear tiles.

11. The plate according to claim 1, wherein the liner plate is a matrix material and the primary wear tiles are cemented carbides metallurgically bonded to the matrix material.

12. The plate according to claim 1, wherein the primary wear tiles are cast in the metal matrix material.

13. The plate according to claim 11, wherein the matrix material comprises iron.

14. The plate according to claim 13, wherein the iron comprises nodular iron.
